(19) United States
(12) Patent Application Publication
(10) Pub. No.: US 2011/0276499 A1
(43) Pub. Date: Nov. 10, 2011

(54) COLLECTING DATA FROM MULTIPLE SOURCES AND AUTOMATICALLY GENERATING A REPORT USING THE COLLECTED DATA, SUCH AS COLLECTING DATA RELATED TO PROPERTY TAXES FROM MULTIPLE SOURCES AND AUTOMATICALLY GENERATING A PROPERTY TAX ASSESSMENT APPEAL

(75) Inventors: Charles Walsh, Seattle, WA (US); Matthew Willis, Seattle, WA (US)

(73) Assignee: ValueAppeal LLC, Seattle, WA (US)

(21) Appl. No.: 12/824,132

(22) Filed: Jun. 25, 2010

Related U.S. Application Data
(60) Provisional application No. 61/331,783, filed on May 5, 2010.

(51) Int. Cl. G06Q 50/00

(52) U.S. Cl. 705/306

(57) ABSTRACT

An system and method for collecting property data from 3rd party resources and determining based on the property data, whether a subject property is over or under assessed by a county tax assessor. A report is generated which includes arguments and evidence for use in appealing the assessment, based on comparable sales, comparable assessments, and answers to questions relating to a subject property.

### CROSS-REFERENCE TO RELATED APPLICATION(S)

This application claims the benefit of the assignee's U.S. Provisional Patent Application No. 61/331,783, filed May 5, 2010 (73462-8001.US00).

### BACKGROUND

In the United States, property tax on real estate is usually levied by local government, at the municipal or county level. The assessment is made up of two components—the improvement or building value, and the land or site value. A tax assessor (“Assessor”) is a public official who determines the value of real property for the purpose of apportioning the tax levy.

When assessing a residence, the Assessor, usually in conjunction with an appraiser, investigates the selling prices of all other similar houses in the area, the cost of replacing it if it gets destroyed, and a calculated price that the house should sell for. In some areas, other property characteristics, such as the view and/or natural surroundings may be also evaluated. Then, the Assessor assigns a value which typically lies within this calculated range.

A county typically calculates the county's yearly budget based on a projection of properties taxes collected within the counties jurisdiction. One problem with this approach is that the Assessor may tend to pick, when evaluating the assessment amount for a subject property, homes having higher selling prices despite the existence of similar homes having lower selling prices. This problem is amplified in weak real estate market, where selling prices have dropped relative to a prior year and county budgets are depleted.

The result is that the homeowner is often assessed an unfair amount in property taxes. In most if not all assessment jurisdictions, the determination of value made by the assessor is subject to some sort of administrative or judicial review, if the appeal is instituted by the property owner. However, each county has different, and often confusing, rules governing the appeals process and the evidence required for a successful appeal.

Filing an appeal with the local tax authority is often an opaque, expensive and time-consuming process. The homeowner is often left with either the option of paying the unfair assessment or spending valuable resources to navigate the county's appeals process and gathering technical documentation for arguing to the appeals Board that the homeowner's property was assessed above a fair market value.

Another problem for the homeowner is gathering and documenting the evidence to present to the Board. Typically at the appeal, the Board will require evidence in contradiction to the comparable properties used by the Assessor when assessing the homeowner's property (“subject property”). The average homeowner does not have the resources to argue against the Assessor nor the access to a detailed list of comparable properties having similar characteristics to the subject property but with lower sales prices.

Even when the homeowner has access to a list of comparable properties, a problem exists of accurately comparing multiple properties, each of which may have a property characteristic, such as a damaged roof, or an addition of an extra bedroom/bathroom, which affects the properties value.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description

### BRIEF DESCRIPTION OF THE DRAWINGS

FIG. 1 is a block diagram of a basic and suitable computer that may employ aspects of the described technology.

FIG. 2 is a block diagram illustrating a simple, yet suitable system in which aspects of the described technology may operate in a networked computer environment.

FIG. 3 is an illustration of several data structures (“configuration data objects”) used to group and categorize property and county characteristics relating to a subject property.

FIG. 4 illustrates an overview 400 of the evaluation process of determining whether a subject property was over-assessed by a county tax assessor.

FIG. 5 is a flow diagram illustrating a user's perspective of the system.

FIG. 6 is an example of a webpage which provides an input for entering a property identifier, such as a property address, for determining whether a property has been over assessed by a county tax assessor.

FIG. 7 is an example webpage presenting to the user a revised assessment, estimated savings, and a snapshot of evidence presented on a “ValueAppeal” report.

FIG. 8 is an example display of a list of comparable properties.

FIG. 9 is an example illustration of a grid layout presentation of the comparable properties.

FIG. 10 is an example of a document that details offline steps the user is requested to perform, based on the county rules for the county of the subject property.

FIG. 11 is an example of a letter addressed to the county on behalf of the user requesting a lower tax assessment.

FIG. 12 is an example of an evidentiary document which summarizes arguments for lowering the property tax assessment based on Comparable Sales, Unequal Assessments, and other information.

FIG. 13 is an example Comparable Sales document that is included in the Report generated for the user.

FIG. 14 is an example document, included in the Report, detailing Unequal Assessments for use in lowering a subject property's tax assessment.

FIG. 15 is an example of the Comparative Analysis tool.

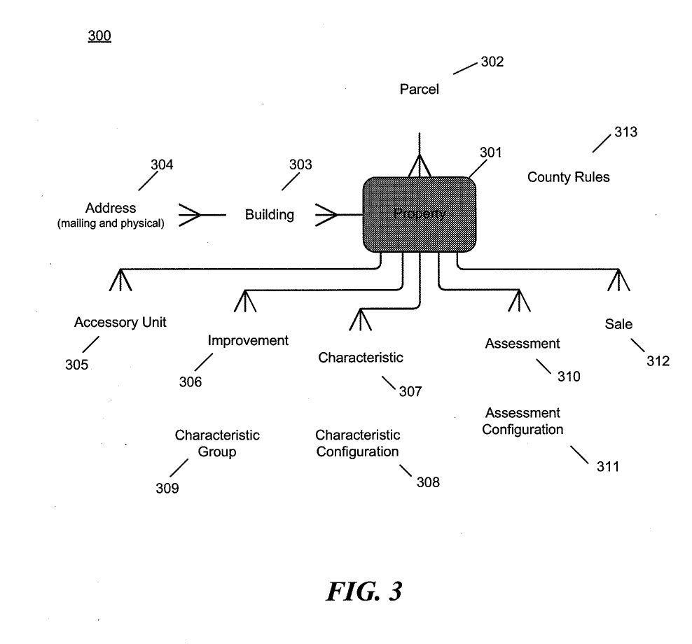

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 304 is first introduced and discussed with respect to FIG. 3).

A portion of this disclosure contains material to which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

Note: the headings provided herein are for convenience and do not necessarily affect the scope or interpretation of the described technology.

### DETAILED DESCRIPTION

The described technology collects data from multiple sources and automatically generates a report using the collected data. For example, data related to property taxes, such as comparable sales data, comparable assessments, and other data, may be collected from multiple sources, such as various counties throughout the United States. The described technology allows a user to create a custom evidence report based on the collected data in an easy-to-use online interface. For example, a homeowner (“user” or “Appellant”) may use the online interface to create a custom property tax assessment appeal for his or her property.

Various implementations of the technology will now be described. The following description provides specific details for a thorough understanding and enabling description of these implementations. One skilled in the art will understand, however, that the described technology may be practiced without many of these details. Additionally, some well-known structures or functions may not be shown or described in detail, so as to avoid unnecessarily obscuring the relevant description of the various implementations.

The terminology used in the description presented below is intended to be interpreted in its broadest reasonable manner, even though it is being used in conjunction with a detailed description of certain specific implementations of the technology. Certain terms may even be emphasized below; however, any terminology intended to be interpreted in any restricted manner will be overtly and specifically defined as such in this Detailed Description section.

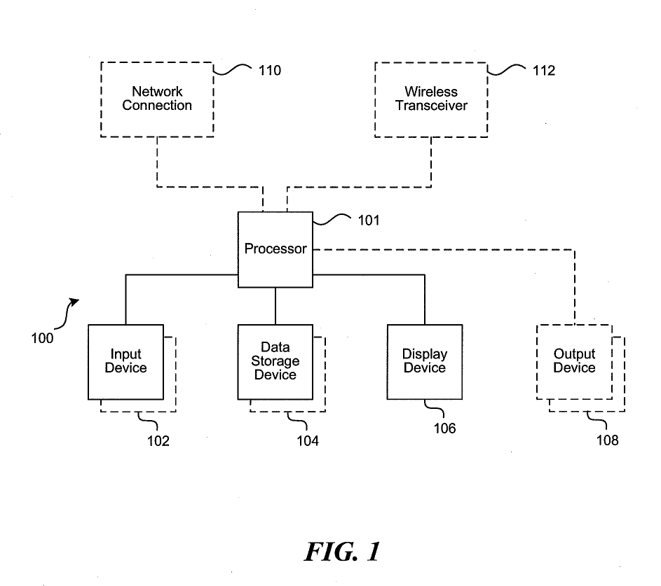

FIG. 1 and the following discussion provide a brief, general description of a suitable computing environment in which aspects of the described technology can be implemented. Although not required, aspects of the technology may be described herein in the general context of computer-executable instructions, such as routines executed by a general or special purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

The described technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Those skilled in the relevant art will recognize that portions of the described technology may reside on a server computer, while corresponding portions reside on a client computer. Data structures and transmission of data particular to aspects of the technology are also encompassed within the scope of the described technology.

Referring to FIG. 1, in some implementations, the described technology employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN), or the Internet (not shown in FIG. 1).

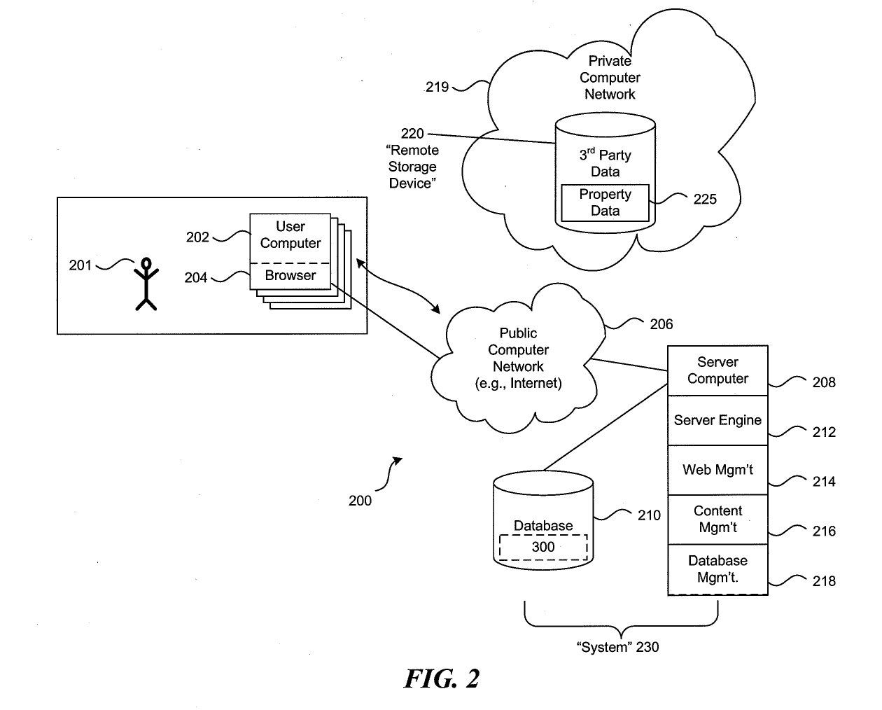

Aspects of the described technology may be practiced in a variety of other computing environments. For example, referring to FIG. 2, a distributed computing environment with a web interface includes one or more user computers 202 in a system 200, each of which includes a browser program module 204 that permits a user 201 to utilize the computer to access and exchange data with the Internet 206, including remote storage devices 220 within a private network 219, and web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, property data, audio signals, and electronic images. A private network 219, such as an intranet, may indeed be additionally or separately accessed in some applications. The network may have a client-server architecture, in which a computer is dedicated to serving other client computers, or it may have other architectures such as a peer-to-peer, in which one or more computers serve simultaneously as servers and clients. One or more databases 210, coupled to the server computer(s), stores much of the web pages and content exchanged between the user computers and the remote storage devices 220. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the implementations described herein. The database management component includes storage and retrieval tasks with respect to the database, queries to the database, and storage of data.

### Configuring the Data

A property is defined as a real property item purchased in a sale transaction. A property can consist of one or more buildings, a parcel and various additional units. Typically, every county within a state collects and stores property data 225, in a remote storage device 220, to use for determining the taxable value (“assessed value” or “assessment”) of the property (“subject property”).

Property data 225 is gathered, to a Real Property Assessment System (RPAS or “system”) 230, where it is distributed, at a database 210, into several conceptual data structures 302-312 that allow the system to characterize and analyze a particular property 301. FIG. 3 illustrates several data structures (“configuration data objects”) used to group and categorize property and county characteristics relating to a subject property. In some implementations, one or more data structures 301-312 are designed to maintain the original property data 225. In other implementations, the one or more data structures 301-312 are designed to maintain both the original property data 225 and a second property data (not shown) calculated at least from one or more original property data.

In some implementations, each county is analyzed for varying rules such as how often a property is reassessed as well as the rules for which a property owner must adhere to when filing an appeal. For example, a county date range rule specifies which sales can be used when determining comparables and what constitutes necessary evidence. In some implementations, these rules are stored and evaluated at a county rules data structure 313.

A parcel data structure 302 stores information particular to the land or lot of a particular property. For example, a lot size is important for lot size analysis of properties that do not Share land.

A particular property 301 also has an address data structure 304 and a building data structure 303. In some implementations, an address data structure stores the mailing address and the physical address, such as lot and block number, of the particular property The building data structure 303 stores the number of buildings separately assessed by a county property tax assessor for a particular property. For example, if a single parcel contains multiple buildings, each separately assessed by the county, the system 230 stores separate data for each building such that the content management component 216 analyzes these properties differently than, for example, an average house having a single building.

In some implementations, a sale data structure 312 determines and stores a particular property's sales status, such as a whether the property was sold under a ‘warrantee deed’, ‘foreclosure’, ‘short sale’, and others transactions that may or may not be problematic for use as evidence, based on a particular county rule 313 used by a county's appeal process.

Typically, a property is assessed at regular intervals based on a county rule 313 or state law. In some implementations, the system 230 stores, at an assessment data structure 310, a record of an assessment for each year in order to establish the rules for appealing that year, regardless of whether or not a house was assessed that year. From the assessment data structure, the system determines and stores the information needed to establish the date that an Appellant can start an appeal, the deadline for appeal and the particular county rules for appealing that cycle.

Each county determines how and when (a “window”) an appeal can take place during the cycle of a given year. For instance, in California many counties allow an informal appeal hearing near the first part of the year and a formal hearing during a second part of the year. This time frame “window” is identified and captured by the system. Additionally, a particular county may have rules that vary at different points along the appeal cycle. The details of each county's appeal cycle and the county's applicable appellate rules are stored at the assessment configuration data structure 311 where they are configured and associated with the correct county rules, forms, and other county information.

Additionally, each county has different ways of determining taxable value as well as the tax rate. The system collects and stores, at the assessment configuration data structure 311, the tax assessment for a given year from other 3rd parties. In some implementations, the system estimates the tax assessment for a given year based on a tax assessment from a previous year. In other implementations, the system calculates the tax assessment for a particular property based on 3^{rd} party tax sources and/or algorithms for establishing an estimated tax rate. These rules are stored at the assessment configuration data structure 311.

In addition, many counties have additional assessment exemptions, stored at the assessment configure data structure 311, such as senior exemptions and state laws which restrict how a house can be assessed.

The system also stores, at an improvement data structure 306, a property's improvements and the value of those improvements for use in determining, by the system, improvements to a comparable that occurred after its sale date. This is important, for example, for indicating any new improvements that may be present in the property characteristics but not in the historic sale price.

The system also stores, at an accessory data structure 305, any unit or aspect of the property data 225 with a dollar value. This is used to determine additional value for a property's assessment or sales price. For example, the additional value is used as part of the calculation of determining a current assessment value of a property and, when considering a comparable, the additional value is compared against the additional value of the subject property.

White some data structures are shown in FIG. 3, the system may employ more (or fewer) data structures.

For each particular property 301 gathered from a county or private network 219, a variety of characteristics, specific to the particular property, are stored and manipulated in a characteristic data structure 307. Some of these characteristics are described below; however, the system can use many other characteristics.

For example, a particular property may have a building type, such as an apartment unit, condominium, duplex, triplex, house, apartment building or any other building type. Additionally, a particular property may have a zoning code such as, for example, residential, commercial, or land without a building or improvement. In some implementations, the content management module 216 of the system 230 determines, based on the property data 225, whether a particular property is, for example, a condominium with a shared lot, a house with its own parcel 302, or a commercial building with multiple lots.

Some characteristics relate to a quality or condition of a certain aspect of a particular property, such as the number of bedrooms, condition of a roof, or whether the property has a garage.

Some characteristics may be a requirement of a specific county. For example, Fairfax County, VA has a ‘Construction Quality’ characteristic that defines the quality of construction. The county may indicate that all comparable properties (“comparables”) used as evidence in opposing a tax assessment must have the same value for the quality of construction. In this case, the content management module 216 stores the value of the quality of construction in the characteristic data structure 307. The Fairfax county requirement that all comparables include the ‘Construction Quality’ characteristic is stored as a county rule in a county rules data structure 313 such that all comparables in that county are in accordance with the county rule.

The system analyzes each property characteristic for its usage frequency to determine how often it is used by a county property tax assessor, if at all. The relevancy of a property characteristic is analyzed to determine whether the characteristic should be utilized in determining comparables and other evidentiary material for use in arguing a lower property tax assessment.

In one implementation, each property characteristic is analyzed for its distribution. For example, a roof condition value may be scaled from 1-10, the existence of a swimming pool may be stored as a true/false or yes/no value, or a neighborhood description may be stored as a text description. In addition, the scale a county uses to measure a characteristic may not be linear. Using the same example above, a county may have a scale of 1 to 4, 1 being ‘Poor’, 2 being ‘Average’, 3 being ‘Good’ and 4 being ‘Luxury’. ‘Average’ may be predominant, ‘Good’ may be of marginally greater value than ‘Average’, and ‘Luxury’ may be of substantially greater value than ‘Good’. This nonlinear scaling is stored at the system for determining a ranking of comparables for use as evidence that a subject property received a higher than average property tax assessment. For example, in some counties a majority of houses are indicated as average construction, but there may be a few that are of high quality construction. This would be an indicator that construction quality may be important in making sure that comparables of like characteristics are selected by the system when determining comparables for a subject property.

The system 230 may analyze each property characteristic for its fidelity and significance. For example, the system analyzes a property characteristic for its reliability (does the property characteristic show up for a county 100% of the time), or significance (does the property characteristic have a single data type or mixed data). The system 230 may determine, automatically, additional information about the significance of a property characteristic and how a particular county utilizes a property characteristic for assessment purposes. Additional information may also be manually entered directly into the database 210 without a traversal of the public computer network 206.

Each property characteristic may be modified to represent a numerical representation of the data or a more quantifiable representation. For instance, a county may indicate that the style of the house is ‘1-story’, ‘2-story’ or ‘ranch’ style. If the county considers ranch style superior to the other two, components of the system 230 create a yes/no version of the ranch style so that the system can augment a house's value when comparing one that is a ranch with one that is not. The system may maintain each property characteristic in the original format used by a county and create a new property characteristic that represents the numerical representation of the data or the more quantifiable representation. Therefore, the system 230 can supply the most appropriate viewpoint for any property characteristic, regardless if being presented to the county, who may desire the original format, or the system that may need a more detailed and normalized format.

Each property characteristic is given at least two descriptions: one description to communicate to the county Assessor the original data point that is being represented and another description understood by the Applicant. For example, the system 230 gives each property characteristic a description that would communicate to a county Assessor the original data point that is being represented. Alternatively, or additionally, the system gives a description that communicates an understanding to an Appellant 201, who may need more details to enhance the arguments put forth throughout the appeals process.

At the end of this modification process, the system 230 has created a series of extra linear scales and yes/no values, such as ‘Has View’=yes or no vs. ‘Building Quality’ 1-100, for use in weighting and comparing property characteristics.

In some implementations, each property characteristic is weighted for its impact on comparisons. The system uses a point system which typically ranges in values from 0 to 50,000 points. For example, a bathroom may be valued at 7500, a bedroom at 15000 and a well desired view at 30,000. Most property characteristics will have little or no weight and some will have significant impact. The result will be that a house with two extra bedrooms may be considered of similar value as a house that has one bedroom and a good view. These weights are determined based on factors including, but not limited to, 1) the Assessors opinion of the property characteristics, 2) a market value calculated at the system and 3) the results of a hedonic regression analysis of the property data 225 and/or the property characteristics.

After the system determines the usage and significance of a property characteristic, some of the data for a particular property characteristic may be sparse; however, this lack of data does not necessarily mean its lack of existence. For instance, a county may only have records indicating a Bedroom count for 50% of their houses in their storage system 220. In this case, the lack of a value as stored, at the database 210, as “unknown” instead of 0. This will deem this characteristic non-impacting at the time of analysis if the data is not present; however, all comparables that have this characteristic will be treated accordingly.

In some implementations, each property characteristic can also be identified as a required match or a near match for a property to be considered a valid comparable for evidentiary use. For instance, the system 230 may determine that comparables must be in the same neighborhood as the subject property. In this case, the system creates an Offset Weight to impact any difference for these values.

In addition, the system 230 may use a range, stored at a characteristic configuration component 308, to signify an appropriate property characteristic value to use in determining comparables for the subject property. For instance, to select only comparables built within 20 years of the subject property the characteristic configuration component 308 sets a range for this Offset to +/−20.

In some implementations, the use of the range is enforced when the system determines that it is reasonable to do so. For example, if a county rule 313 restricts all comparables to have the same neighborhood code, but during analysis the system determines that there are only two property sales with the same code, then the system will deem that restriction unreasonable. If neither the county nor the system can make a suggested assessment, based on a particular restriction, the restriction is ignored.

In some implementations, the database 210 also allows for the grouping of property characteristics into a characteristic group component 309. Grouping multiple property characteristics can improve comparable analysis as well as make it easier for the county and the Appellant to understand the data. Property characteristics can be grouped in multiple configurations. For example, a group can be based on summation group or maximum impact group.

A summation group can be described by an example. For instance, if the original property data 225 is broken up into bathrooms of Full, Half and Quarter sizes, a summation group is created that stores the sum of all bathrooms. Storing both the original property data and the summation group retains fidelity while creating a group relationship.

A maximum impact group can be described by an example. For instance, if the original property data 225 is of differing aspects of the same characteristic, such as ‘View of Lake’ vs. ‘Territorial View’, the system weighs them separately but groups them so that only the value having the most impact is presented to the Appellant. In other words, if the total score for ‘View of Lake’ is 10,000 and the score is 5,000 for ‘Territorial View’, then the system would utilize the score of 10,000 for comparing Views between comparable properties. However, the Appellant will be presented the “View: Lake, Territorial” description.

The system determines whether or not a particular property characteristic is helpful for the Appellant to use in making a decision to choose a particular comparable as evidence. If the system 230 determines that a particular property characteristic is appropriate or helpful in advocating that the subject property was assessed too much property taxes by the county, that particular property characteristic for the comparable is displayed in a final report for use in the county appeals process.

The user not need enter a property's assessed value into the system because that data 225 used to determine the property's assessed value and calculate whether the property is over assessed is previously stored at the system. The system can automatically generate a list of over assessed properties without requiring input from the user. The system can use the list, which at least contains the owner's name and mailing address, to automatically contact the owner and recommend use of the system to lower their property's assessment.

### The Evaluation Process

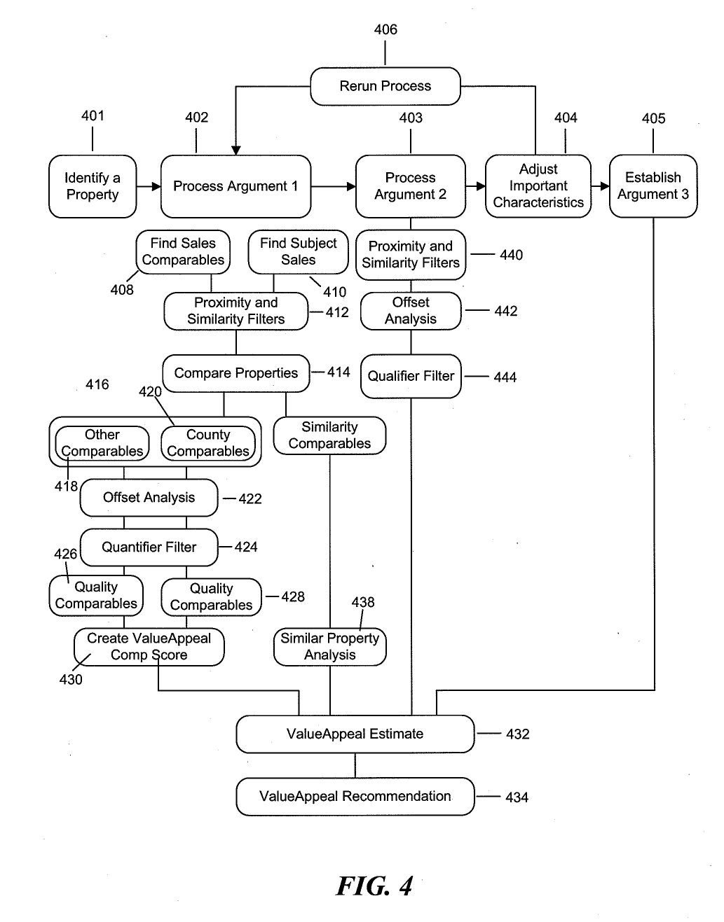

FIG. 4 illustrates an overview 400 of the evaluation process of determining whether a subject property was over-assessed by a county tax assessor.

Identifying a Property

A user (“Appellant”) 201 enters their property (“subject property”) into a webpage or other portal 401, provided by the system 230, in order to determine if their property was over-assessed and whether or not there is enough evidence to support an appeal. The user can enter the subject property's address or parcel ID at module 401 to identify their property from other properties stored by the system 230.

The user does not need to enter the property's assessed value into the system because that data 225 used to determine the property's assessed value and calculate whether the property is over assessed is previously stored at the system.

If the system cannot locate the subject property, the system determines, at module 401, whether other properties having the same zip code of the subject property are stored in the database 210. If so, the system returns to the user the other properties that are within a ¼ square mile radius of the subject property. While zip codes are used in this example, other geographic designators may be employed, such as latitude and longitude, census zones, The Lot and Block Survey System, etc.

Once a property is identified, the system associated the property with the county rules 313 of the property's county. For example, the system associates the subject property with the county's assessment-cycle rules for the desired assessment year, including a rule governing an allowable range of sales to use when assessing a property and a rule governing the quality of arguments required for a successful appeal.

The evaluation process 400 contains three major algorithms (“arguments”) 402, 403, and 405 used to lower the value of a subject property's tax assessment. Argument 1 is based on a comparable sales selection algorithm which the system uses to determine the best arguments for lowering the subject properties assessed value based on a sale price of a comparable. Argument 2 is based on a comparable assessment selection algorithm which the system uses to determine the best arguments for lowering the subject properties assessed value based on a county's assessed value of a comparable. The algorithm of Argument 3 (405) allows the system to create a series of questions to encourage a user to provide information that will help the success of their appeal and more accurately describe their subject property.

Argument 1 Analysis—Comparable Sales

In some implementations, the Argument 1 module 402 encapsulates other modules 408-438 which the system 230 uses to identify and analyze comparables for use as evidence in reducing a subject property's assessment.

At module 408, the system locates, on the database 210, one or more comparables based on the subject property. At module 410, the system identifies any sales of the subject property that could create an issue or help the user's appeal. For instance, module 410 identifies any sales of the subject property that may cause an issue with an appeal. For example, the user may have purchased their property at a time near the assessment date and for a greater value than the assessment value. As this information may lend to a key piece of evidence that the subject property is under assessed, the algorithm 402 may recommend to the user that they do not proceed in appealing their case to the county property tax assessor or appeal board. However, the contrary may be true. For example, the user may have purchased the subject property at a time near the assessment date and for a lower price than the assessed value. This will factor into a positive attribute when the system calculates whether the property is over assessed.

Comparable filters 412 may used to identify any sale that is within reasonable similarity to the subject property. A similarity filter 412 filters comparable properties based on several factors including, for example, 1) validity of the sale, 2) the number of bedrooms, 3) the number of bathrooms, 4) the amount of living space, 5) the size of the lot (only for non-condos) 6) price of the sale and 7) the type of house (condo, single-family, duplex, etc). The system adjusts the similarity filter 412 based on the makeup of a particular area. For example, a more rural area may allow larger deviations of lot size, whereas an urban area will allow less deviation.

In addition, a comparable filter takes into account the “Proximity” of a comparable to the subject property. The proximity filter 412 may limit the distance a comparable can be from a subject property, based on a density of sales in the area surrounding the subject property—the higher the density, the smaller the radius, and vice versa. In some implementations, the maximum radius for a selected comparable property sale is determined by the county rules 313.

The system 230 then identifies, at module 418, “ValueAppeal comparables” that are candidates for making the argument that the subject property is over assessed. In some implementations, a ValueAppeal comparable is compared to a subject property to determine if the comparable property has 1) a similar or lower sales price when compared to the subject property's assessed amount and 2) similar or slightly more valued characteristics (such as more living space) as compared to the subject property.

Module 420, the County Comparable Candidates, indicates that a property may be properly or under assessed based on 1) a similar or higher sales price as compared to the subject properties assessed amount and 2) similar or slightly less valued characteristics as compared to the subject property. For each potential appeal, components of the system 208 proactively collect a list of comparables that the county may use to rebut a case for lowering an assessment. The system may calculate a ratio for each county for which a property exists in the database 210. The system uses the ratio to determine whether or not the county has a strong enough case to refute evidence gathered by the system 208. For example, if the system can identify 10 sales comparables that make a strong case for lowering an assessment but the county can identify 12 quality sales to make their argument for their original assessment, provided that the ratio is 1.1 or lower, the system provides a recommendation to the user not to attempt an appeal of the assessment.

In order to compare properties of differing property characteristics, at module 422, the system establishes an offset weight for each characteristic. Each weight is applied to characteristic differences between the subject property and a comparable property, for each particular characteristic. The total amount of weight applied to a property is based on the addition of all Characteristic Scores for a particular property.

The system may calculate a Characteristic Score for each property characteristic based on a pre-established weight which is applied against the value of a property characteristic. This score is then used to compare characteristics of differing values for different properties. For instance, if the subject property has 4 bedrooms and the comparable has 2 and the Weight is 100, then an example formula is (2*100)−(4*100). The score is then used to create a relative value for that score based on the original assessment value of the property. Therefore, the score will result in larger value differences for characteristics for a high valued property than for an average property.

The Characteristic Score expresses the summation of all of the characteristic values of the comparable minus the summation of all the characteristic values of the subject property. The net result of the scoring are relative property characteristic values that the system uses to create a more level comparison of properties based on each property's individual characteristics. For example, if the subject property is assessed at $300,000 with a territorial view worth $25,000, and a comparable sold for $275,000 with a view of a lake, worth $50,000, the module 422 subtracts $25,000 from $50,000 and creates a relative sale price of $250,000 (275,000−25,000). In other words, if the comparable had only a territorial view like the subject property, the scoring expresses the likely selling price for the comparable.

In some implementations, the system weights all property characteristics with a value of zero (“0”) unless another value is not pre-established. In other implementations, where the value of a particular property characteristic cannot be determined because the data source is unreliable, the value is recorded as undeterminable (“Null”) and the property characteristic is excluded from the property characteristic comparison and scoring.

Using the offset weights, module 422 can then determine the characteristics for each comparable that is the same or similar in value. The system performs a series of tests to determine whether or not a particular offset for a particular characteristic is relevant. For instance, if there are zero sales within a 1.5 mile radius that has the same Neighborhood Code (a value that a county rule has indicated must match for a sale to be considered) as the subject property, then module 422 determines that this is not a fair restriction and the system removes the particular characteristic and the associated offset from the evaluation. Similarly, if only a small and insufficient amount of comparables have the same Neighborhood Code, for example, module 422 will use a portion of the offset weight to setup the report and recommend certain properties, not necessarily eliminating properties that do not meet the criteria.

Additionally, a comparable's Land Value can be calculated. Using the ratio between the subject property's Land Value vs. Improvements Value, a “Land Adjustment Ratio”, as well as the relative values for comparable properties within the same geographic or neighborhood area, module 422 determines the relative value of a comparable property having a different lot size than that of the subject property. In some implementations, this value is subtracted from the Sale price to equalize the differences between the comparable's sale value and the subject property's assessment value. The system may not perform this calculation for properties that share land with other properties, such as condominiums.

Additionally, a comparable's Relative Adjusted Sale Value can be calculated. The Relative Adjusted Sale Value is an adjusted sale price used, by module 422, to account for any improvements or additions made to comparable property since its last recorded sale. The comparable's Relative Adjusted Sale Value equals the comparable's sale amount plus the summation of the comparable's improvement costs, subject property's additional unit value, minus the summation of the comparables additional unit values, the characteristic adjustment amount and the land value adjustment.

Example Formula

$$Comparable ' s Relative Adjusted = Sale Amount + Comparable ' s Improvement Costs - Comparable ' s Additional Units Value + Subject ' s Additional Units Value - Characteristic Adjustment Amount - Land Value Adjustment .$$

The Sale Amount is the sale of the property for a comparable. The comparable's Improvement Costs is used to help make the sale amount more accurate. For example, if a property is purchased in 2008 for $200,000 and $50,000 is invested in improvements to the property, the assessor will likely update the value of the property characteristics in 2009. If an appeal is processing in 2009, the improvements are not calculated in the price since they hadn't existed on the date the property was sold and, therefore, the $200,000 purchase price in 2008 is not an accurate representation of that sale relative to the 2009 data. Module 422 adds the improvement value to the sale price ($200,000+$50,000) to create a more relevant sale price. A comparable and subject property Additional Unit Value are included in the calculation for determining a comparable's relative adjusted sale value because the subject property's value is reflected in the sale price, but yet the comparable's value must be removed to create a level comparison between the two properties.

In some implementations, after all of the quantitative data is analyzed, the system groups both the county comparables 420 and “ValueAppeal comparables” 418, at module 426 and module 428 respectively, into Quality Groups to calculate if enough evidence exists. If an adequate number of Quality Comparables exists to make a case for the user, the system will recommend that the user not appeal. In some implementations, a minimum of four (4) Quality Comparables is required, while in other implementations, based on a county rule, this limit is raised to maximize the success of an appeal.

In order to ensure the production of quality comparables, modules 426 and 428 perform a series of checks that will potentially eliminate a comparable from the selected comparables.

Module 426 is used to determine whether any ValueAppeal comparables qualify for elimination. The following examples may eliminate a ValueAppeal comparable from being used as evidence:
Insignificant Adjustment—if the comparable's Adjusted Sale price is larger than the configured range which would result in an insignificant assessment adjustment, the system removes that comparable from the selected comparables. For instance, if the adjustment minimum is 10% and the subject property is assessed at $200,000, any comparable that has an adjusted sale price greater than $180,000 is eliminated.
Suspect Comparable—if the comparable's Adjusted Sale price is smaller than a configured range, the system considers that comparable suspect. For instance, if the adjustment maximum is 40% and a subject property has an assessed value of $200,000, any comparable that has an adjusted sale price smaller than $120,000 will be eliminated.
Improvements—if the comparable has improvements that were completed between the Assessment date and after the comparable's sale date, module 426 eliminates that comparable.
Price Per Square Foot—module 426 determines the sale price to square feet of living space ratio (sale amount/square feet) and eliminates any comparables that have a higher dollar per square foot.

Module 428 is used to determine whether any county comparables qualify for elimination. The following examples may eliminate a county comparable from being used as evidence:
Quality Comparables—If a county comparable does not meet the criteria of a Quality Comparable, then the system removes it.
Adjusted Sale Price—if the Adjusted Sale Price is less than the Assessment amount, then the system removes that comparable.
Sale Price—if the Sale Price is less than the Assessment amount, then that comparable is removed.

In some implementations, a ValueAppeal ComparableScore is calculated as, for example, a grade between A and C− (A, A−, B+, B, B−, C+, C, C−) that represents the likelihood of using a comparable as ah argument to lower the assessment of the subject property. An example ValueAppeal ComparableScore equals the Comparability plus the summation of the Adjusted Sale Price Ratio, Age, Distance, and Total Characteristic Difference Score.

Example ValueAppeal Formula

$$Comparability + Adjusted Sale Price Ratio + Age + Distance + Total Characteristics Difference Score$$

‘Comparability’ is a term used to describe absolute differences between properties, irrespective to whether they are positive or negative characteristics. In other words, it simply expresses how different the properties are from each other. The ‘Sale Price Ratio’ is the ‘Relative Adjusted Sale Value’ divided by subject property's assessed amount, which is an indicator of how strong of a case this comparable will be from a sale price and property value standpoint. ‘Age’ is the age of the comparable where the older the age of a comparable, the less relevant it is. The more recent comparables will influence the finding of a higher grade. ‘Distance’ refers to the distance of a comparable to the subject property. Similar to age, comparables that are closest to the subject property and will result in higher grades. ‘Total Characteristics Difference Score’ is similar to the ‘Characteristic Adjustment Amount’, described earlier; however, here the system is only concerned about the difference in score, not the difference in price adjustment.

In addition, module 430 performs a similar formula from the standpoint of the county assessor in order to analyze the quality of the county's comparables that may be used to justify the original county assessment. An example ‘County Assessor Comparable Score’ equals the ‘Comparability’ plus the ‘Age’ and the ‘Distance’ minus the summation of the ‘Adjusted Sale Price Ration’ and the ‘Total Characteristics Difference Score’.

Example County Formula:

$$Comparability - Adjusted Sale Price Ratio + Age + Distance - Total Characteristics Difference Score$$

Regardless of whether a comparable makes a case for over assessment or under assessment, in some implementations, module 438 lists comparables that are 1) most similar to the subject property in terms of property characteristics, 2) closest to the subject property and 3) were sold nearest to the subject property's assessment date. From this list, module 438 determines the average assessment value based on several levels of scope. For instance, if the subject property is assessed for $250,000 and the ten most similar, closest, and recent comparables average a price of $200,000, then the user has a strong case for an appeal. If the reverse is true, this would factor into the overall case success probability as a negative value.

In some implementations, the module 432 pre-selects recommended comparables based on a combination of the comparables' ValueAppeal ComparableScore, Sales Price, and the quantity of Comparables, as well as the results of Argument 2 (403) and Argument 3 (405).

In some implementations, depending on the county rules, the system at module 434 establishes a different set of criteria to determine whether a property is over-assessed, based on:
Number of Quality Comparables
Number of County Comparables
Whether or not the subject property was sold near the assessment date and whether or not that will help or hurt the case to lower the assessed value of the subject property.
Total overall adjustment—for instance, an annual savings of $25 may not be worth the work it takes to appeal.

Argument 2 Analysis—Unequal Assessment

Argument 2 (403) includes a set of modules 440-444 that form an algorithm which selects comparable properties within a more constrained distance than performed in Argument 1 (402) and where the comparables are similar to the subject property and assessed at lower values than the subject property.

The Assessment Filter, Module 440, identifies assessed properties that are within reasonable characteristic similarity to the subject property. An identified assessed property can be used as a comparable property (“Comparable Assessment”) if the assessed property passes through a filter that looks at factors including, but not limited to: 1) the number of bedrooms, 2) the number of bathrooms, 3) the amount of living space, 4) the size of the lot (only for non-condos) 5) amount of the assessment and 6) the type of house (condo, single-family, duplex, etc).

In addition, the filter takes into account proximity 440, which utilizes approximately half of the distance used for proximity under the Argument 1 (412) analysis. The system determines an allowable distance from a subject property to a Comparable Assessment based on the density of properties in the area surrounding the subject property—the greater the density, the smaller the radius, and vice versa. The maximum radius is determined by a county rule 313.

Similar to Argument 1, module 442 takes offsets into account such that the Comparables Assessments conform to county rules 313 and assessment configuration restrictions 311.

In some implementations, similar to 424, module 444 performs a series of checks to ensure the quality of Comparable Assessments. For example, some of the checks or qualities include, but are not limited to:

Value Per Square Foot—the assessed value to square feet of living space ratio (assessment value/square feet) is determined such that any Comparable Assessments having a higher ratio is eliminated.

Allowances—similar to Comparable Offsets, allowances are configured based on county rules which specify which characteristics are crucial for accurate comparisons. If a Comparable Assessment deviates from any of these allowances the system eliminates it from a list of comparables that are recommended to the user to use as an argument for reducing the subject properties tax assessment.

Argument 3

The algorithm of Argument 3 (405) creates a series of questions to encourage a user to provide information that will help the success of their appeal and more accurately describe their subject property. For example, a question may ask, “Does your house have any significant damage such as a leaky roof or cracked foundation that would affect its value in a negative way?”

In some implementations, the questions of Argument 3 are pre-established and independent of the subject property. In other implementations, the questions are dynamically created by the system 230 based on one or more criteria established from Argument 1 (402) and/or Argument 2 (403).

Answers to the questions of Argument 3 are used in establishing the ValueAppeal Estimate 432 and, in some implementations, the ValueAppeal Recommendations 434.

### An Overview of the Comparable Selection Process

In order to maximize a user's chance of success, the system 208 guides the user through the selection and modification of evidence to use to lower the assessed value of a subject property.

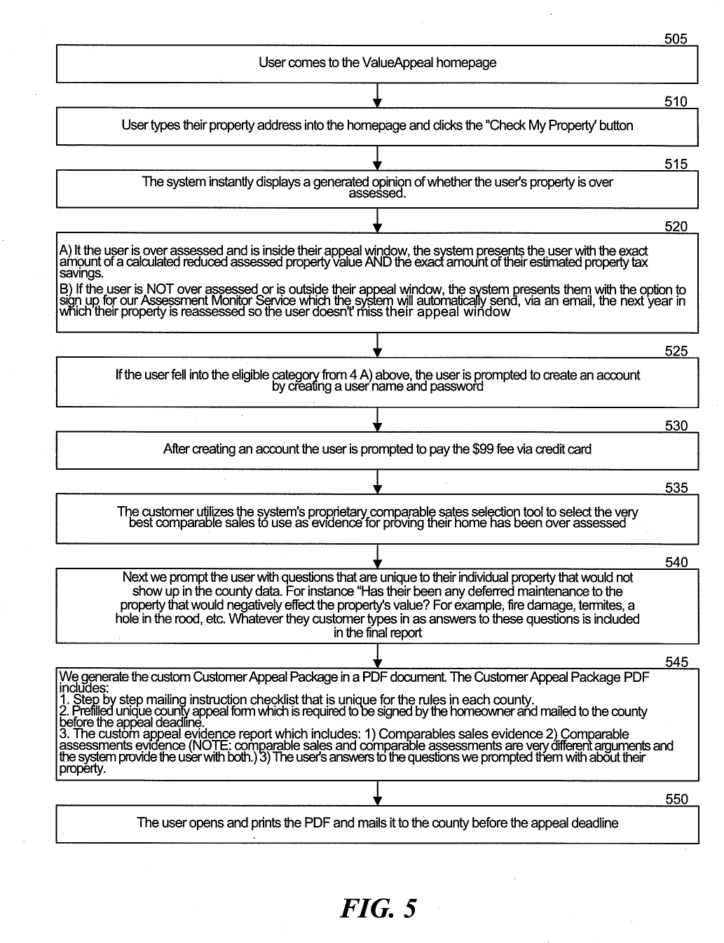

FIG. 5 is an overview of the system from a perspective of a user. Each step, 505-550, is an incremental and self-explanatory step taken by the user to determine whether the user's property was over or under assessed by a county tax assessor.

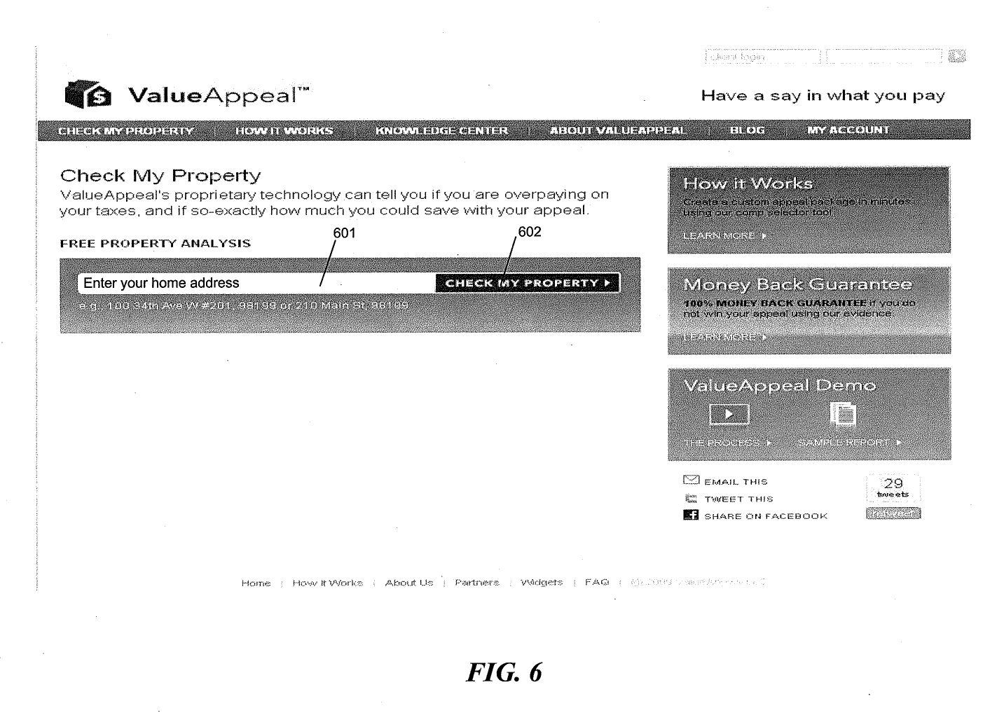

FIG. 6 is an example of a webpage which provides an input 601 for entering a property identifier, such as a property address, that a user can submit 602 to the system 208 for determining whether the user's property has been over assessed by a county tax assessor.

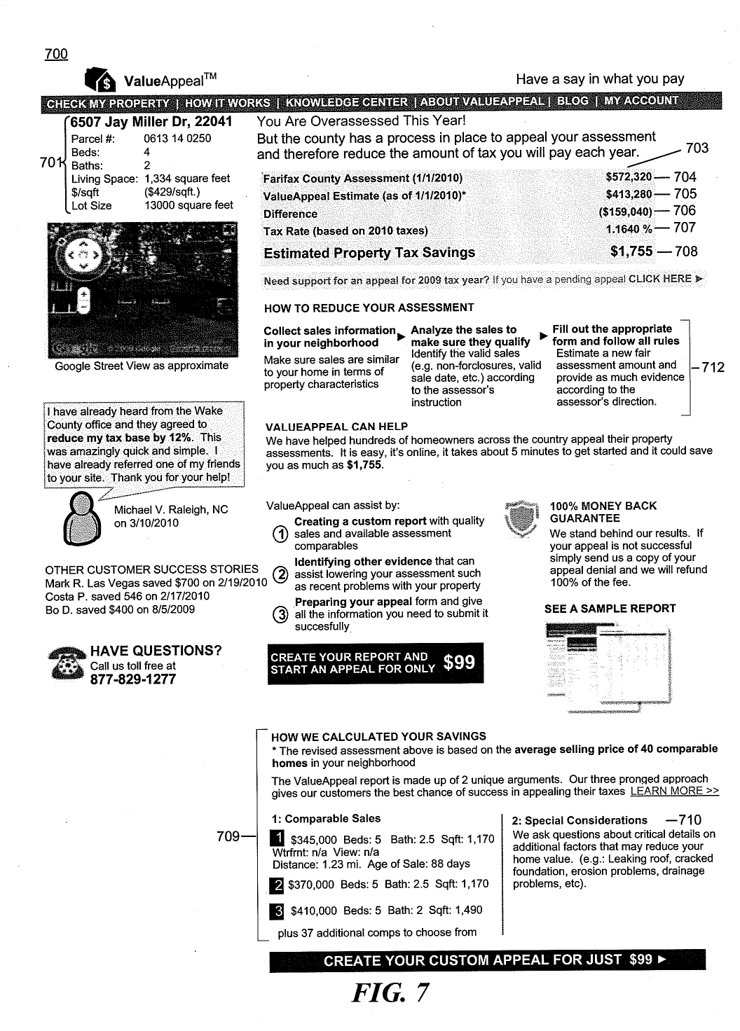

FIG. 7 is an example webpage where the user will be presented their revised assessment 705, their estimated savings 708 as well as a snapshot of some of the evidence 709 that will be presented on their report.

In some cases the user may notice that some of the subject property data 701 is incorrect such as, their Bedroom count is stored by the county as 4 and it is really 3. In this case, the user is directed to correct their data and rerun the process (not shown).

The user is instructed 712 to attempt to make the claim that the data is inaccurate if the change will result in reducing the potential value of their property. Users are typically not adequately versed on building codes and the parameters of how data is recorded by the county so it is not recommended that they attempt to make this claim unless it will help to lower their assessment.

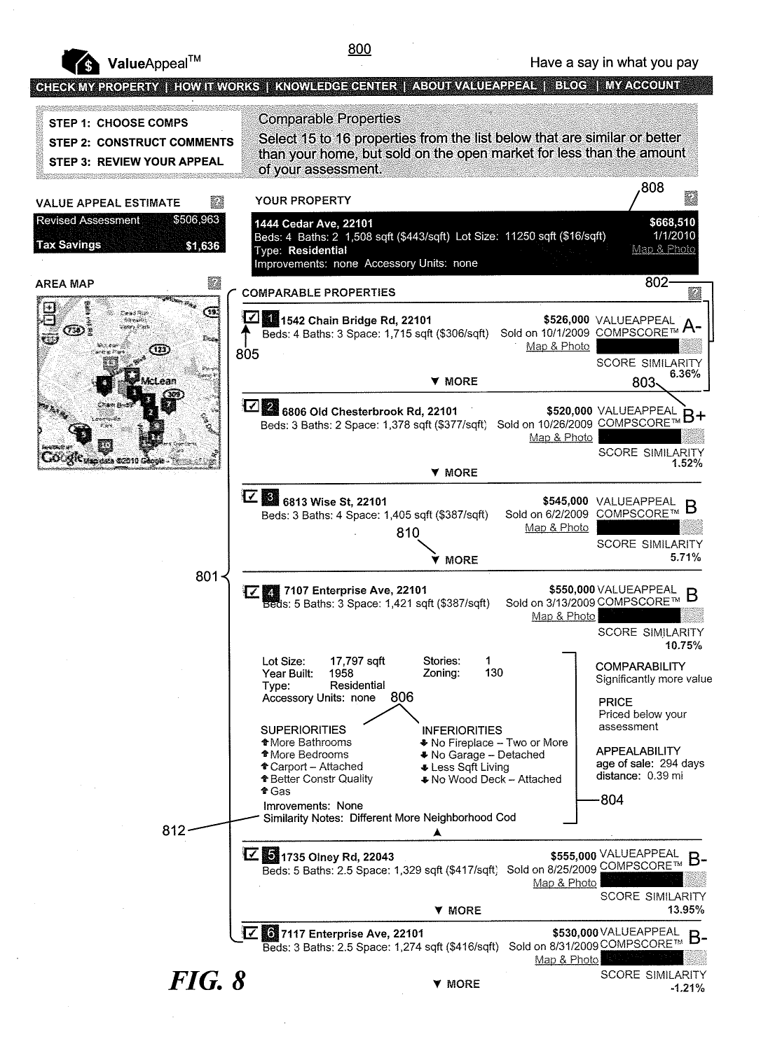

FIG. 8 is an example display of a list of comparable properties 801. The user is presented with 2 to 30 Comparables to analyze and choose from. All the primary property characteristics 804 are shown as well as the relevant differences in characteristics 806 between the Subject property and the comparable. In addition, the ValueAppeal Comp Score 803 is presented to help the user to choose 805 the comparables that will make the strongest case for appeal.

All the comparables and differences are listed in relation to the subject property 808 in order to help the user decide which to choose. The ValueAppeal Estimate is adjusted based on the selections that they choose.

The user can use the quick view 802 which shows the main data points or they can expand the “more” section 810 to see more detailed comparison results 804 as well as any similarity issues 812 that are determined using the Comparable Offsets, described above, such as “this house is in a different neighborhood.”

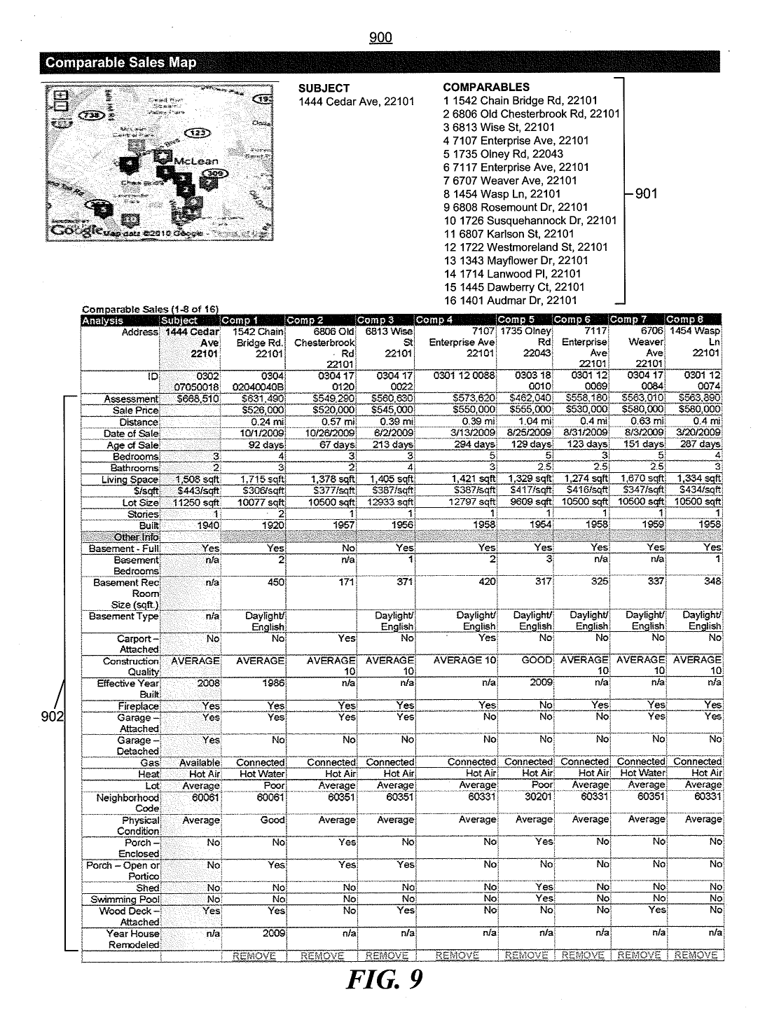

FIG. 9 illustrates a grid layout presentation of the comparable properties. The grid page shows the comparables 901, selected by the user in FIG. 8, in a view that is easier for them to analyze the differences in all the property characteristics 902.

After the user has selected their comparables, the user is prompted to answer a series of questions and provide evidence that may help the user's chance of success or assist the user in lowering the assessment further.

The questions presented (not shown) to the user are created based on, among other things, a county rule 313 of the subject property's county. The questions are designed to draw out any issues or characteristics of the property that may not be represented in the data but are very important. An example question is, “Do you have any damage to your roof or cracks in your foundation?” If this is the case, a description of the issue will help the assessor understand the need for a reduction in the assessment.

In some implementations, the user can upload pictures (not shown) that document evidence related to the above questions in order to further strengthen their case.

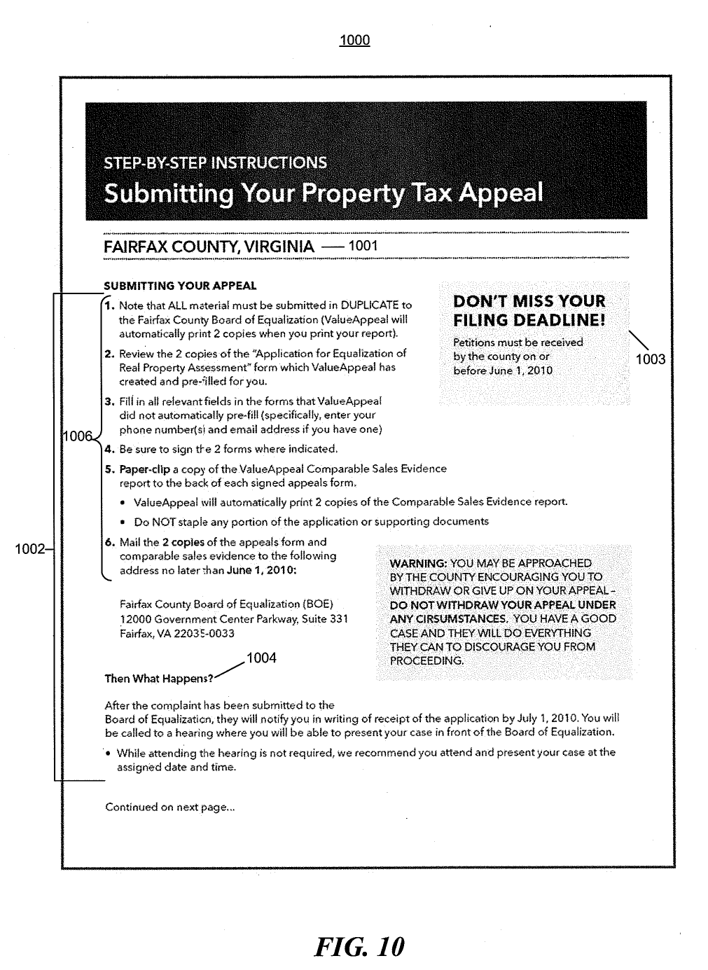

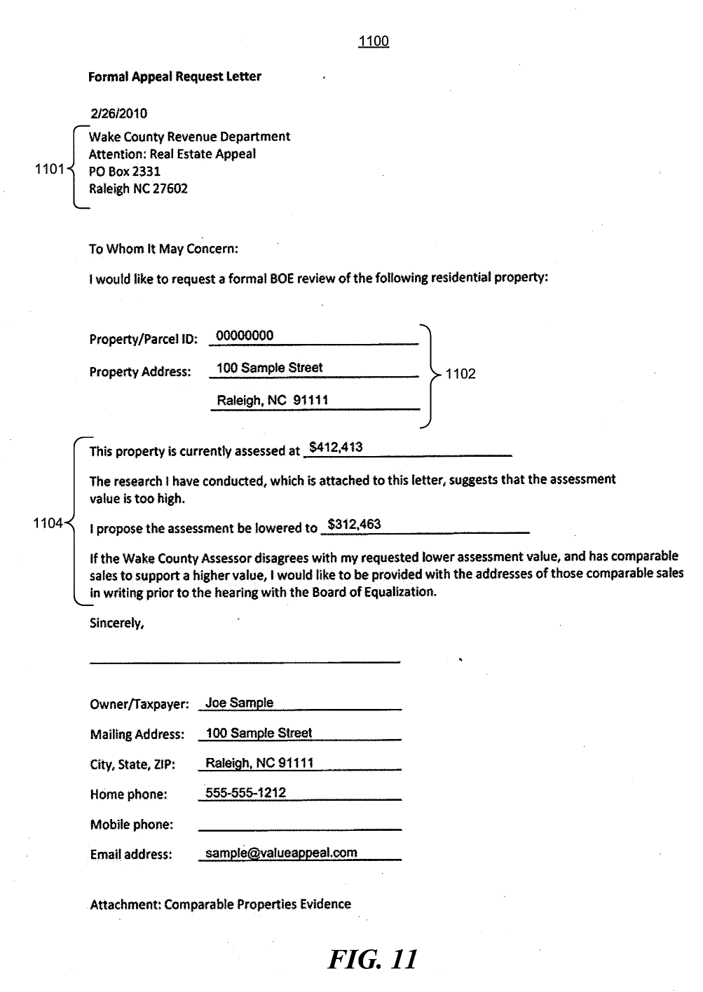

The final steps in the process are illustrated in FIG. 10 where the user is presented their final steps 1002 and their report FIGS. 11-13.

FIG. 10 details the offline steps 1002 the user is requested to perform, based on the county rules for the county of the subject property. The checklist 1006 will help the user understand the next steps for their particular county 1001 such as where to submit the appeal, how many copies to make, what to expect from the assessor, etc. In many counties there are specific steps or events 1003 that an appellant needs to be aware of in order to help the success of the appeal. For example, in some counties the assessor will attempt to talk an appellant out of submitting an appeal so coaching is provided to help them respond to such a conversation. This checklist 1001 is custom built for each county and is designed to allow them to complete the process without having to log into their account or re-visit the website.

In some implementations, the report includes a letter 1100 as displayed in FIG. 11. The letter is addressed to the county 1101 and includes pre-filled details 1104 arguing for a lower tax assessment.

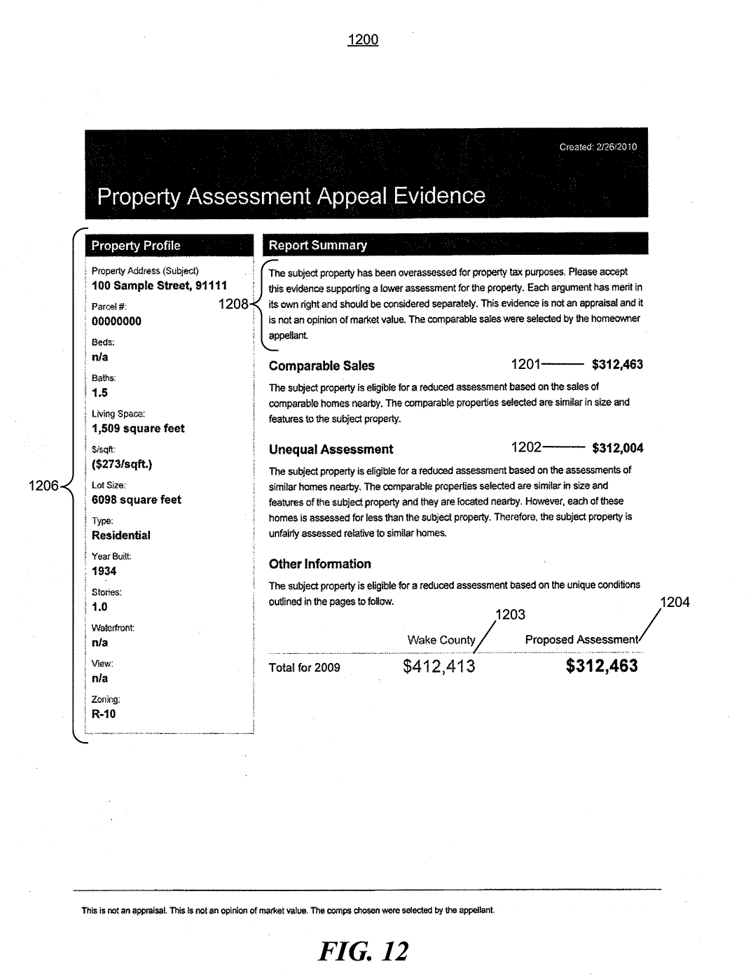

In some implementations, the report also includes the Property Assessment Appeal Evidence, as illustrated in FIG. 12. This document contains, for example, a snapshot of the information gathered from Argument 1 (1202) and Argument 2 (1202). In some implementations, the Evidence Report includes all three arguments as well as a general description of the subject property 1206 and why there is cause for an appeal 1208.

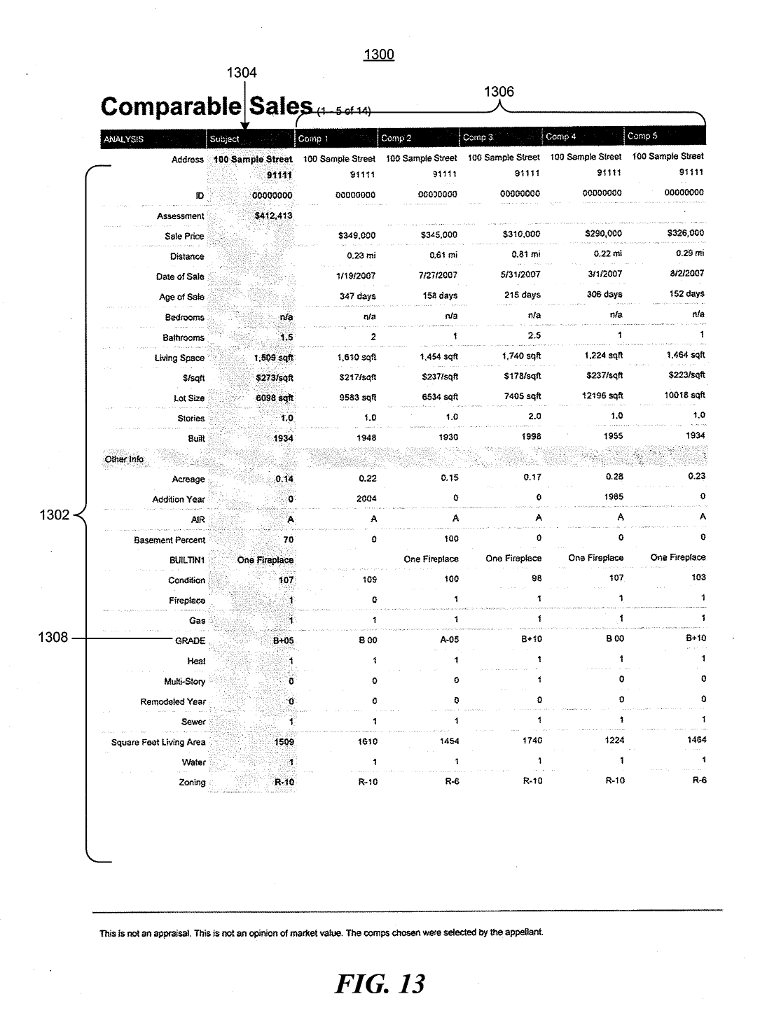

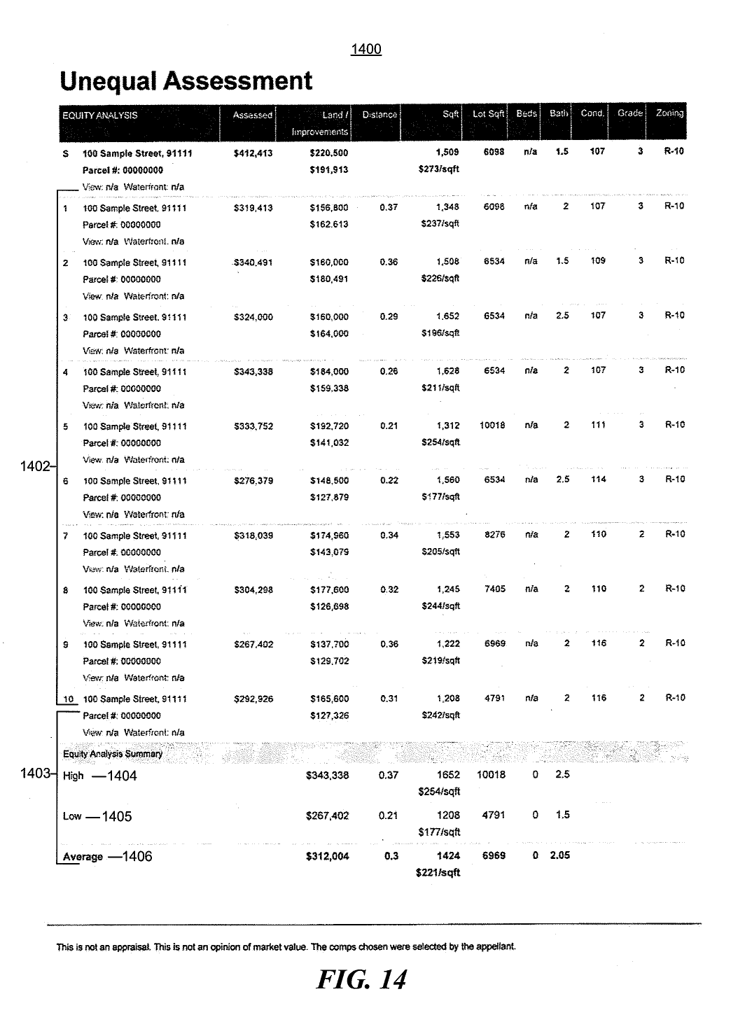

The report is designed with particular data points and information that will maximize the appellant's chance of success. In some implementations, the report includes the comparable sales 1306, as illustrated in FIG. 13, and the Unequal Assessments 1402, as illustrated in FIG. 14, each of which were previously determined in Argument 1 and Argument 2, respectively. The comparable sales show property characteristics 1302 as well other characteristics that we determined in the data configuration process will help the user win an appeal. For example, if the county has indicated that Building Grade 1308 must match for all comparable properties we configure that report to show that characteristic. However, if the system 208 has determined that there are not enough sales with that Building Grade, for example, then this discrepancy is communicated to the county and it is explained why the report includes comparable properties having the restricted characteristic.

There are also a set of tools to help an appellant after they have submitted their appeal that in many counties play a role in their success.

The system 208 additionally provides a blog and FAQ that are updated regularly to reflect current information about certain methods of each county, their different terminology or how to understand the process, rules or laws. For example, in Fairfax County, VA, a user is allowed to submit an appeal for up to two years in the past. Therefore, the system will recommend, during their ValueAppeal experience, that the user creates an appeal for any years to which they qualify.

Argument 4

Some counties will respond to an appellant with contrary evidence to that of the ValueAppeal report; however, the user may not be prepared to identify the flaws of that evidence. In addition, some users have questions about why particular comparables were or were not recommended. The system 208 provides tools to help the user identify issues with a particular sales comparable.

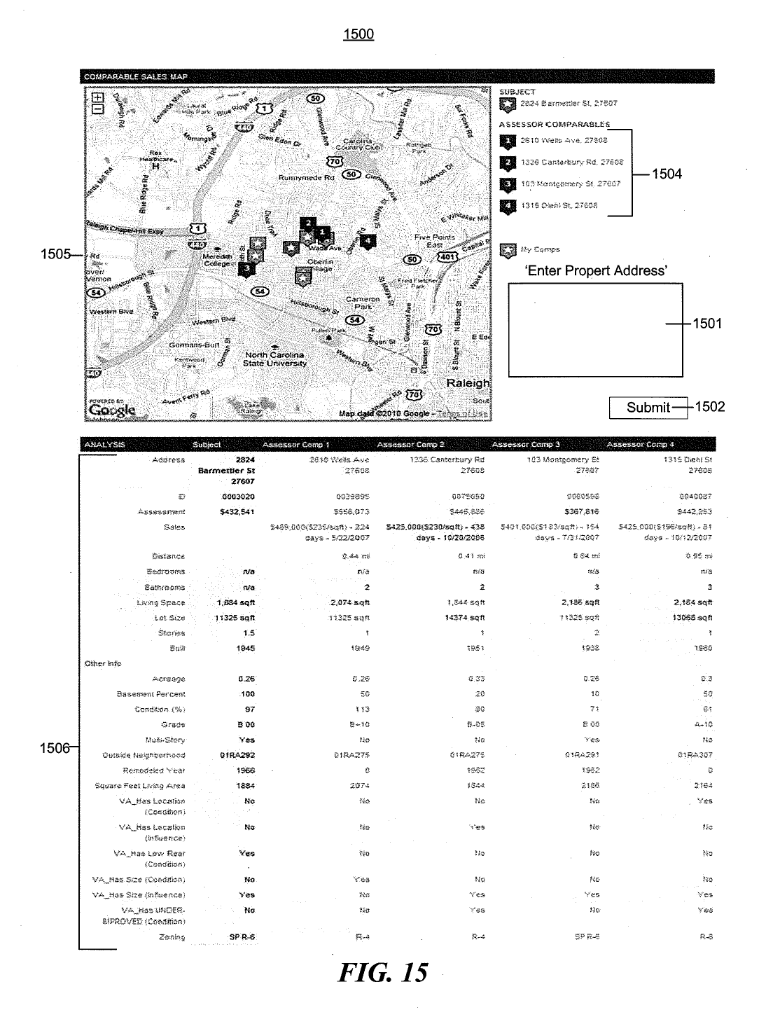

For example, the Comparative Analysis tool, FIG. 15, allows a user to enter any property addresses or parcel keys into a tool 1501 to show the user why a particular comparable was not included in their report as well as why a particular comparable is note a proper assessment. In King County, WA, for example, the county will send an appellant a list of 3 to 8 comparables 1504 that they believe most accurately represent the assessment value, however, the county may deliver the information to the user without reference to the number of bedrooms and bathrooms that house may have, for example. Without the Comparative Analysis tool 1500, a user wouldn't realize that the county may be comparing their property to a property with a much better property characteristic.

The system herein is applicable to other methods and system to automatically gather data from third party data sources, analyze that data for discrepancies relative to a previously provided data, and generate reports that provide evidence of the discrepancy. For example, the medical industry can utilize the system to find data discrepancies and abnormalities in a patient's medical and/or insurance records. For example, an organization can utilize the system to determine if a Beneficiary is entitled to receive benefits from an entitlement agency, such as the Social Security Administration. Similarly, a car agency can use the system to determine the value of a driver's trade in vehicle.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

We claim:

1. A method of generating a property tax assessment appeal report from a server, based on a subject property, the method comprising:
receiving an address or identifier uniquely identifying the subject property, wherein the subject property has one or more characteristics accessible by the server;
selecting, from a first database of properties, a first set of comparative properties each having one or more characteristics similar to a respective one or more of the subject property characteristics,
wherein each comparative property of the first set has a lower sale value than an assessed value of the subject property, and
wherein each comparative property of the first set is selected based on one or more rules accessible by the server;
selecting, from a second database of properties, a second set of comparative properties,
wherein the second set includes comparative properties calculated to be utilized by a tax assessing authority to determine the assessed value of the subject property; and
generating a report including a first section having the first set of comparative properties and a second section having the second set of comparative properties.

2. The method of claim 1, wherein at least one of the one or more rules specifies a duration occurring before an assessment date of the subject property, and wherein comparable properties used to determine the assessed value of the subject property have a sales date within the duration.

3. The method of claim 1, further comprising:
applying one or more metric values as weighting factors to the one or more characteristics of the comparative properties of the first set,
wherein each metric value is based on utilization of the one or more characteristics by the tax assessing authority to assess the value of the subject property;
determining a comparative score for each of the one or more comparative properties of the first set,
wherein each comparative score is based on the characteristic score of a respective one of the one or more comparative properties and a physical radius of the respective one comparative property from the subject property; and
determining a characteristic score for each of the one or more comparative properties of the first set,
wherein each characteristic score is calculated based on a difference between the weighted one or more characteristics of at least one of the comparative properties and a corresponding weighted one or more characteristics of the subject property,
wherein the one or more characteristics of the subject property are weighted using the one or more metric values,
wherein the radius varies in proportion with a density of the comparative properties relative to a location of the subject property, and
wherein the first section of the report further includes a recommended comparative property based at least on the comparative scores of the one or more comparative properties and a quantity of the one or more comparative properties.

4. The method of claim 1, further comprising determining a characteristic score for each of the one or more comparative properties of the first set, wherein each characteristic score is calculated based on a difference between a weighted one or more characteristics of at least one of the comparative properties and a corresponding weighted one or more characteristics of the subject property, and wherein the one or more characteristics of the subject property are weighted using one or more metric values.

5. The method of claim 4, further comprising determining a comparative score for each of the one or more comparative properties of the first set, wherein each comparative score is based on the characteristic score of a respective one of the one or more comparative properties and a physical radius of the respective one comparative property from the subject property.

6. The method of claim 5, wherein the radius varies in proportion with a density of the comparative properties relative to a location of the subject property.

7. The method of claim 5, wherein the first section of the report further includes a recommended comparative property based at least on the comparative scores of the one or more comparative properties and a quantity of the one or more comparative properties.

8. The method of claim 1, wherein the second database and the first database form a common database, and wherein the receiving of the address or identifier includes receiving the address from a web browser at a geographically remote user computer.

9. A system comprising:
a data object module configured to store one or more rules to select a comparative property for use in determining whether a subject property was over assessed by a tax authority;
a processing module configured to select, from a tax assessment database, multiple comparative properties,
wherein each of the multiple comparative properties has one or more property characteristics substantially similar to a corresponding one or more characteristics of the subject property,
wherein each of the multiple comparative properties has an assessment value lower than an assessment value of the subject property,
wherein each of the multiple comparative properties is selected within a physical radius from the subject property, wherein the radius varies in proportion with a density of the comparative properties relative to
a location of the subject property, and
wherein a physical radius is determined based on a rule stored at the data object module;
a filtering module configured to remove, from the multiple comparative properties, a comparative property having a property characteristic not in accordance with a rule of the one or more rules stored at the data object module; and
a weighing module configured to determine a weight to apply to at least one of the one or more characteristics of the multiple comparative properties,
wherein the weight is a metric value applied to a specific characteristic of the one or more characteristics based on a rule of the one or more rules stored at the data object module.

10. The system of claim 9 further including, a report module configured to generate a report including a first portion having the first set of comparative properties and a second portion having the second set of comparative properties.

11. The system of claim 9, wherein the report further includes a risk assessment recommendation indicating a likelihood of lowering the assessed value of the subject property, wherein the recommendation is based on at least one of the multiple comparative properties having the weight applied to one or more of it's characteristics.

12. The system of claim 9, wherein a rule of the one or more rules stored at the data object module specifies that each comparative property of the multiple comparative properties must have property characteristics based on a number of bedrooms, a number of bathrooms, and an amount of living space.

13. The system of claim 9, wherein the one or more rules stored at the data object module are gathered at least from multiple, different county tax authorities.

14. A system for creating a property tax appeal evidence report, the system comprising:
a means for determining multiple comparative properties each having one or more characteristics similar to a corresponding one or more characteristics of a subject property,
wherein each of the multiple comparative properties was sold prior to an assessment date of the subject property,
wherein each of the multiple comparative properties was sold for less than an assessment value of the subject property;
a means for permitting a user to select a first set of the multiple comparative properties;
a means for selecting a second set of the multiple comparative properties, wherein the comparative properties of the second set have an assessment value less than the assessment value of the subject property;
a means for generating one or more questions to the user to encourage the user to input information to increase a likelihood of reducing the assessed value of the subject property,
wherein the one or more questions are based at least on the one or more comparative property characteristics similar to the corresponding one or more characteristics of the subject property; and
a means for generating a report, wherein the report has at least the first set of comparative properties, the second set of comparative properties, and the one or more subject property details for reducing the assessment value of the subject property.

15. The system of claim 14, further comprising a means for receiving, from the user, answers to the one or more questions, wherein the answers provide details to reduce the assessment value of the subject property.

16. The system of claim 14, further comprising a means for analyzing pre-selected comparative properties to determine one or more deficiencies in at least one of the pre-selected comparative properties, wherein the one or more deficiencies increase a likelihood that at least one of the pre-selected comparative properties was improperly used to calculate the assessment value of the subject property, wherein the pre-selected comparative properties are selected by a tax accessing authority.

17. A computer-readable medium having computer-executable instructions for execution by a processing system, the computer-executable instructions for creating a data aggregation system, when executed, cause the processing system to:
receive a set of property data,
wherein the set of property data has multiple comparable properties each having one or more characteristics, and
wherein the one or more characteristics each have an original format used in tax or valuation assessment;
normalizing the one or more characteristics of at least one of the multiple comparable properties; and
generating a report having the one or more characteristics in the original format and a corresponding one or more characteristics of the normalized characteristics,
wherein a first part of the report has the one or more characteristics in the original format to present an argument to lower an assessed valuation of a subject property, and
wherein a second part of the report has the corresponding one or more characteristics of the normalized characteristics to present a likelihood of lowering the assessed valuation of the subject property.

18. The computer-readable medium of claim 17, further comprising, scoring each of the multiple comparable properties based on the corresponding one or more characteristics of the normalized characteristics, wherein a comparable property having a low score is excluded from the report, and wherein the score is based at least on an importance of the one or more characteristics as applied by a tax assessor.

19. A computer implemented method of automatically producing a report for use by a user in adversarial proceedings between the user and a third party such as an appraiser, the method comprising:
receiving information regarding a disputed property or right;
automatically gathering from external data sources at least some data regarding the disputed property or right,
wherein the external data provides information supporting both the user and the third party;
automatically analyzing the received information and the gathered information to generate at least one argument for use in the adversarial proceeding; and
producing a report for use by the user in the adversarial proceeding based on the automatically generated argument.

20. The method of claim 19, wherein the adversarial proceeding is a property tax assessment hearing, the disputed property is real estate owned by the user,
wherein the gathered data is comparable real estate data, and
wherein the report includes instructions for the user in submitting data for the hearing and includes data in a format used by the appraiser.

21. The method of claim 19, wherein the disputed right relates to a denial of government benefits.

22. The method of claim 19, wherein the disputed property or right is used personal property such as a used car.

23. The method of claim 19, wherein the method further comprises determining whether to recommend to the user to enter into the adversarial proceeding before producing the report.

24. The method of claim 19, further comprising presenting to the user several valuation questions related to the disputed property or right to elicit responses helpful in automatically generating another argument to include in the report.
